(19) United States
(12) Patent Application Publication
(10) Pub. No.: US 2004/0220821 A1
(43) Pub. Date: Nov. 4, 2004

(54) Bidding method for time-sensitive offerings

(76) Inventors: Arthur Dale Ericsson, Houston, TX (US); Tommy Eugene Hall JR., Houston, TX (US)

Correspondence Address: John R. Casperson, PO Box 2174, Friendswood, TX, 77549, US

(21) Appl. No.: 10/645,034

(22) Filed: Aug. 21, 2003

Related U.S. Application Data
(60) Provisional application No. 60/466,659, filed on Apr. 30, 2003.

(51) Int. Cl. G06F 17/60

(52) U.S. Cl. 705/1; 705/37; 705/26

(57) ABSTRACT

The invention provides a method for auctioning a time sensitive item. An item which needs to be sold by a specified time is first identified. The item is offered for sale at an auction. Bids for the item are received from at least one bidder, and the item is sold to the highest bidder. In one embodiment, surplus tickets for capacity-limited events are identified and sold on an internet auction site.

### CROSS REFERENCES TO RELATED APPLICATIONS

This application claims the benefit of U.S. Provisional Application No. 60/466,659 filed Apr. 30, 2003.

### BACKGROUND OF THE INVENTION

The invention relates generally to auctioning property, services or accommodations for which a vendor needs a commitment to purchase by a specified time.

Many ticket events such as for travel and for entertainment take place at specified times. At times, there are unused tickets shortly prior to the event which are of no value unless sold. In one aspect, the invention relates to a method for selling such tickets.

In the airline industry, particularly, there is currently much excess seat capacity. An empty seat generates no income for the airline company. However, there is no good way to sell the seat near the time of departure. Similar problems exist in professional sports, baseball for example, where interest has waned since the seats were built, or where the increased interest and attendance counted on when the facility was built has not materialized, and, in certain cases, for cruise ships, Olympic events, and concerts.

At some point, each of these concerns would be better off if the seat were sold at whatever the market would bear. One object of the invention is to provide a method for accomplishing this.

Other types of service businesses similarly have unallocated resources available from time to time which fail to generate income. In the freight service business, trucks, ships, trains and planes generally must depart at a specific time with or without a full load. In the lodging services business, hotel rooms, beach and ski condominiums and weekly rental units, and resort time shares must be occupied in order to generate income. In the equipment and automobile rental services business, items which are unrented during periods of availability constitute wasted resources. Other service businesses offering the use of facilities, such as amusement parks and golf courses, have periods of time during which the facilities are underutilized. Similarly, businesses offering personal services, such as limousine rentals, fishing guides, moving companies, photographers, beauty salons, tanning shops, and tutors have days or appointment periods which are unfilled.

Another object of the invention is to provide a method and system for more fully engaging available accommodations or services in advance.

At times, there is a need for a vendor to sell property prior to a specified time. For example, a business may need to sell inventory prior to end of lease date for a warehouse storing the items, or prior to a closing date where a warehouse has been sold. Similarly, a consumer may need to sell off the contents of a storage unit prior to a lease renewal to be in a position to terminate a lease, or sell specific items such as an automobile or a dining room set prior to a move. A business or a consumer may need to sell a piece of property prior to a payment due date in order to pay off a loan, or make a tax payment, or avoid being responsible for a loan or tax payment. In such situations, failure to dispose of the property prior to a date certain can cost time and money.

A further object of the invention is to provide a method and system for selling property prior to a specified time.

### SUMMARY OF THE INVENTION

In one embodiment, the invention provides a method for auctioning a time sensitive item.

An item which needs to be sold by a specified time is first identified. The item is offered for sale at an auction. Bids for the item are received from at least one bidder, and the item is sold to the highest bidder.

In accordance with another embodiment of the invention any surplus capacity, according to predetermined criteria, for providing accommodation or services at a specific future time or time period is identified. A contract to provide all or a portion of such surplus capacity is offered at an auction. Bids for the contract are received from at least one bidder. The contract is sold to the highest bidder, thereby reducing the surplus capacity.

In accordance with another embodiment of the invention, any surplus capacity, according to predetermined criteria, for a future event for which tickets are sold, said future event being capacity limited, is identified. At least one surplus ticket representative of a contract to provide personal accommodation at the future event from said surplus capacity is offered at an auction. Bids are received for the least one surplus ticket from at least one bidder, and the surplus ticket is sold to a highest bidder, thereby reducing the surplus capacity.

### BRIEF DESCRIPTION OF THE DRAWINGS

FIG. 1 is a block diagram which illustrates certain aspects of information flow according to an embodiment of the invention.

FIG. 2 is a block diagram which illustrates certain other aspects of information flow according to an embodiment of the invention.

### DETAILED DESCRIPTION OF THE INVENTION

Broadly, the invention provides a method for auctioning a time sensitive item. An item which needs to be sold by a specified time is first identified. The item is offered for sale at an auction. Bids for the item are received from at least one bidder, and the item is sold to the highest bidder.

In one embodiment, the item to be auctioned comprises a vendor's time-dependent commitment to provide a service. Examples of such services are freight services, personal services, and rental services. For example, the invention would have application to freight services selected from the group consisting of scheduled trucking services, shipping services, air freight services, and rail freight services having excess capacity. As another example, the invention would have application to personal services selected from the group consisting of an opening at a specific time for a limousine rental, a boat charter or tour, a moving company slot of availability, a photographer appointment, a beauty salon appointment, a tanning shop appointment, a tutor appointment. As a further example, the invention would have application to rentals for a specific time period of personal property selected from the group consisting of equipment and automobiles.

In another embodiment of the invention, the item to be sold comprises a vendor's time-dependent commitment to provide an accommodation. Examples of such accommodations include lodging, travel, and ticketed events. For example, the invention would have application to stays for a specific time period in various facilities such as hotel or motel rooms, bed and breakfasts, beach or ski condominiums or weekly rental units, resort time share units, and meeting or banquet facilities. As another example, the invention would have applicability to ticketed scheduled events such as airline flights, bus departures, train departures, cruises, sporting events, concerts, plays and movies. As a further example, the invention would have application to the selling of specific times admissions to an amusement park or tees time for a round of golf.

In a further embodiment of the invention, the invention would have application to the selling of a vendor's real or personal property.

Generally speaking, the offering of the item will be made by the owner of the right to sell the item. However, for businesses having recurring needs, the offering of the item can be made by an internet auction site as an agent of an owner of the right to sell the item and the auction will be conducted on the internet. For such businesses, it is contemplated that the item to be sold will be identified by searching an electronic database belonging to an owner of the right to sell the item, and determination made of whether the owner has a capacity to sell the item. The search can be conducted by the owner or by an agent of the owner, such as the auction site. At a predetermined time prior to the auction, such as one hour prior, the search should be completed, or rerun to verify the owner's capacity to auction the item. Any reserve price contemplated for the item being auctioned should also be determined and set.

Notices will be sent to predetermined recipients at a predetermined time prior to the predetermined auction beginning time, such as 30 minutes prior. The notices would be transmitted over the internet. Examples of notice recipients are auction site members, auction site users, travel agents, ticket agents, web home pages, and internet service provider home pages. The notices could be in the form of communications selected from the group consisting of Emails, pop-up ads, banners and a block advertisements, for example. They would include item information, minimum bid information, auction beginning time and an auction closing time and preferably display a hot button to electronically link the recipient with an address selected from the group consisting of the auction site home page and the auction site for the ticket.

The auction site will generally be a page at an internet auction site. The page would display item identification information, current bid price, and time remaining until end of auction and preferably would include hot buttons for making a bid and for accessing additional information.

Bidders for the item would transmit bid amounts on the item to the auction site as well as bidder identity, contact information and payment information. The payment information could be selected from credit card information, debit card information, and other.

A winning bidder would be determined at the auction end time. After the auction end time, a successful bid notification would be sent to the winning bidder along with a statement of charges, to include a fee charged by the auction site.

In the case of ticketed events, such as airline flights, cruises, sporting events, concerts, and a plays, the auction will be begin at a predetermined auction beginning time prior to the ticketed event. The time of the notices will also be keyed to the event, and notices of the auction sent to the predetermined recipients at a predetermined time prior to the predetermined auction beginning time.

In the case of airline flights, the notices would list at the identification of departure city and time of departure, and the identification of destination city, and preferably would further list carrier identification, class of seat information, and an arrival time in the destination city.

The reserve price for airline tickets can be set based a predetermined relationship with at least one factor selected from the group consisting of:

a) Availability of seats

b) Location of seat or space

c) Time of day the travel/event takes place

d) Time of year the travel/event takes place

e) Weather conditions in either the departure/arrival city

f) If a major event is taking place in either departure/arrival city (e.g., Olympics)

g) Vendor daily profit goal or intended profit margin

h) Actual retail price of travel/event if purchased at that time

i) Average selling price of tickets on the flight or at the event

j) pricing information obtained from the Airline Tariff Publishing Company, and

k) Cost per seat mile multiplied by the number of miles on flight.

It is possible to make this determination mathematically, by computer algorithm.

In accordance with another embodiment of the invention any surplus capacity, according to predetermined criteria, for providing accommodation or services at a specific future time or time period is identified. A contract to provide all or a portion of such surplus capacity is offered at an auction. Bids for the contract are received from at least one bidder. The contract is sold to the highest bidder, thereby reducing the surplus capacity.

The offering of the surplus capacity is generally made by an owner of the right to sell the capacity, although it can be made by an internet auction site as an agent of the owner. The offering will generally be made on an internet auction site. Especially for providers having recurring needs, the surplus capacity is identified by searching an electronic database belonging to an owner of the right to sell the surplus capacity and determining an amount of the surplus capacity available for sale. The searching can be conducted by the owner of the database or by conducted by an internet auction site. The method is especially applicable to events for which tickets are sold.

In accordance another one embodiment of the invention, any surplus capacity, according to predetermined criteria, for a future event for which tickets are sold, said future event being capacity limited, is identified. At least one surplus ticket representative of a contract to provide personal accommodation at the future event from said surplus capacity is offered at an auction. Bids are received for the least one surplus ticket from at least one bidder, and the surplus ticket is sold to a highest bidder, thereby reducing the surplus capacity.

Usually, the offering of the at least one surplus ticket is made by an owner of the right to sell the at least one ticket for the future event. However, the offering of the at least one surplus ticket can alternatively be made by an internet auction site as an agent of an owner of the right to sell the at least one ticket for the future event. Preferably, the offering is made on an internet auction site.

The surplus capacity for the event is identified by searching an electronic database belonging to an owner of the right to sell the least one ticket for the future event and determining a quantity of tickets remaining available for sale. The determination can be made by extrapolative technique, based on ticket sales rate and time remaining, or can further factor in revenue maximization based on past auction sales.

Normally, the searching is conducted by the owner of the database. Alternatively, the searching can be conducted by the internet auction site.

The auction begins at a predetermined auction beginning time prior to the future event. Normally, this will be only a few days prior to the event. Preferably, the searching to identify surplus capacity is conducted about one hour prior to the predetermined auction beginning time.

Notices of the auction are sent to predetermined recipients at a predetermined time prior to the predetermined auction beginning time. Preferably, the notices are transmitted over the internet. Recipients are preferably selected from the group consisting of auction site members, auction site users, travel agents, ticket agents, web home pages, and internet service provider home pages, and are preferably recipients who have requested to be sent such notices. The notices can be in the form of communications selected from the group consisting of an Email a pop-up ad, a banner and a block advertisement, and will preferably list event information, minimum bid information, auction beginning time and an auction closing time. For example, where the event is an airline flight, and the notice preferably lists at least an identification of departure city and time of departure, and an identification of a destination city, and more preferably would further list carrier identification, class of seat information, and an arrival time in the destination city.

In a preferred embodiment, the notice displays a hot button to electronically link with an address selected from the group consisting of the auction site home page and the auction site for the ticket and would be transmitted about 30 minutes prior to the auction beginning time.

It may be desirable to set a reserve price on the at least one ticket. The reserve price can be set by the owner or the auction agent based on factors as identified hereinbelow. Preferably, an algorithm containing such at least one factor would be executed by digital computer to set the reserve price.

Typically, the auction site will appear as page at an internet auction site. The page displays ticket identification information, current bid price, and time remaining until an end of auction, and preferably further displays hot buttons for making a bid and for accessing additional information.

The bidders transmit a bid amount on the at least one ticket to the auction site, and at the same time or previously, transmit bidder identity and contact information to the auction site, as well as payment information. Payment information will generally be selected from the group consisting of credit card information, debit card information, and other.

The auction site determines the winning bidder at the auction end time and transmits, after the auction end time, a successful bid notification to a winning bidder and a statement of charges which typically will include a fee charged by the auction site. An electronic ticket to the future event is preferably transmitted over the internet to the winning bidder.

Preferably, the website is designed to optimize travel and/or event profit by auctioning off available space. Users sign-up and become a member by entering their billing and shipping information including name, mailing/billing address, phone number and email. Members are also given the option of entering travel preferences; age, social security number and drivers license number to streamline the travel process.

Preferred Embodiment - Airline/Train/Bus/Cruise/Travel Tickets
AIRLINE/TRAIN/BUS TICKETS - To raise the percentage of
tickets sold.

| | |
|---|---|
| UNITED AIR | DELTA AIR |
| AMERICAN AIR | NORTHWEST AIR |
| GREYHOUND BUS | AMTRAK TRAIN |

FIXED-PRICE CRUISES - Every cruise leaves the port at capacity.

| | |
|---|---|
| HOLLAND AMERICA | CARNIVAL CRUISES |
| PRINCESS CRUISES | CUNNARD LINE |
| NORWEGIAN CRUISES | CELEBRITY CRUISES |

TRAVEL PACKAGES - Any package centered on a specific event.

| | |
|---|---|
| SUPER BOWL | OLYMPICS |
| DATE-SPECIFIC FESTIVALS | CONVENTIONS |
| SEASONAL TRAVEL | |

The technology is designed to optimize travel profit by auctioning off available tickets. Vendors sign agreement with the auction company to use the auction company site technology to sell off excess ticket and/or capacity. Users sign-up and become a member by entering their billing and shipping information including name, mailing/billing address, credit card number or other payment information, phone number and email. Members will also have the option of entering travel preferences; age, social security number and drivers license number to streamline the travel process.

1) The vendor sets a predetermined time that the auction will start.

(X hours before the travel takes place)

2) One hour before the auction begins, the pricing software searches and identifies departures for a particular vendor with available tickets. (ex. Flights for Delta)

{The software runs this process every 10 minutes.}

3) Thirty-minutes before the auction begins, the pricing software makes one final search of departures for a particular vendor with available tickets.

4) Thirty-minutes before the auction begins, the software sets a beginning auction, selling price based on:

a) Availability of seats

b) Location of seat or space (on flights, first class or coach)

c) Time of day the travel will take place (am/pm)

d) Time of year the travel will take place (season)

e) Weather conditions in either the departure/arrival city

f) If a major event is taking place in either departure/arrival city (ex. Olympics in ATL)

g) Vendor daily profit goal or intended profit margin

h) Actual retail price of travel/event if purchased at that time

i) Average selling price of tickets on the vessel (ex. Plane/Train/Ship)

j) Specifically on airline flights:

a. Pricing and data information obtained from the Airline Tariff Publishing Company

b. Cost per seat mile multiplied by the number of miles on flight

5) Thirty-minutes before the auction begins, the software sends out email notifications to travel agents and interested parties, letting them know that the auction will begin in thirty minutes.

6) Thirty-minutes before the auction begins, the software sends out customized banner and/or block advertisements for posting on travel and/or event related websites informing site visitors of the auction.

7) At a predetermined time before the departure takes place, the auction starts. The pricing software posts the beginning bid price. Consumers win log into the auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the amount of auction item(s) plus any applicable taxes or surcharges.

b) An e-ticket is generated and emailed to the highest bidder.

c) A confirmation and receipt is emailed to the highest bidder.

10) After the auction ends and tickets are sold, The auction company site charges predetermined processing fee(s), for example $1 dollar to the highest bidder and $1 dollar to the vendor selling the ticket.

11) After the auction ends and tickets are not sold, The auction company site will not charge either party any processing fees.

12) After the auction ends and tickets are not sold, the seats or space that was held for the auction becomes available for sale by the airline, bus company, cruise company, travel agents or other channel.

13) Tickets sold at The auction company site are:

a) Non-refundable.

b) Non-cancelable.

c) Non-exchangeable.

d) Not subject to rain-checks or rebates for non-travel.

14) The auction company site is linked to all participating vendors extranet and intranet for real-time pricing and product information and availability.

15) The vendor avoids agent fees for selling the tickets on The auction company site or licensing The auction company site technology for use on their own website.

Preferred embodiment—Amusement Park Admission

AMUSEMENT PARKS—A half-filled park reduces income.

The technology is designed to optimize per day profit by auctioning off remaining operating capacity at Amusement Parks. Vendors sign agreement with The auction company site to use the auction company site technology to sell off excess operating capacity. Consumers wishing to visit these complexes, sign-up and become a member by entering their billing and shipping information including name, mailing/billing address, credit card number or other payment information, phone number and email. Members will also be required to enter preferred date of visit, number of tickets required, number of days spent visiting park, and which amusement park, to streamline the auction process.

1) The vendor sets a predetermined time that the auction will start.

(X hours before the amusement park closes)

2) One hour before the auction begins, the pricing software searches and identifies available operating capacity at a particular Amusement Park. (ex. Unsold tickets at Walt Disney World)

{The software runs this process every 10 minutes.}

3) Thirty-minutes before the auction begins, the pricing software makes one final search of available Amusement Park tickets for a particular vendor.

4) Thirty-minutes before the auction begins, the software sets a beginning auction, selling price based on:

a) Availability of Amusement Park tickets

b) Time of day the Amusement Park visit will take place (am/pm)

c) Time of year the Amusement Park visit will take place (season)

d) Weather conditions in city where Amusement Park visit will take place

e) If another major event is taking place in city where Amusement Park is located

f) Vendor daily profit goal or intended profit margin

g) Actual retail price of Amusement Park tickets if purchased at that time

h) Average selling price of Amusement Park ticket annually

5) Thirty-minutes before the auction begins, the software sends out email notifications to travel agents, ticket promoters and other interested parties, letting them know that the auction will begin in thirty minutes.

6) Thirty-minutes before the auction begins, the software sends out customized banner and/or block advertisements for posting on travel, event and/or Amusement Park related websites informing site visitors of the auction.

7) At a predetermined time before the Amusement Park closes, the auction starts. The pricing software posts the beginning bid price. Consumers will log into the auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the amount of the Amusement Park ticket plus any applicable taxes or surcharges.

b) An e-ticket is sent to the highest bidder via email.

c) A confirmation and receipt is emailed to the highest bidder.

10) After the auction ends and available Amusement Park tickets are sold, The auction company site charges predetermined processing fee(s), for example $1 dollar to the highest bidder and $1 dollar to the vendor selling the tickets.

11) After the auction ends and the available Amusement Park tickets are not sold, The auction company site will not charge either party any processing fees.

12) After the auction ends and the Amusement Park tickets are not sold, the Amusement Park tickets that was held for the auction becomes available for sale by the Amusement Park company, ticket broker or travel agent.

13) Amusement Park Tickets sold at The auction company site are:

a) Non-refundable.

b) Non-cancelable.

c) Non-exchangeable.

d) Not subject to rain-checks or rebates for non-attendance.

14) The auction company site is linked to all participating vendors extranet and intranet for real-time pricing and product information and availability.

15) The vendor avoids agent fees for selling the Amusement Park tickets on The auction company site or licensing The auction company site technology for use on their own website.

Preferred Embodiment - Excess Cargo Capacity (Plane/Rail/Truck/Ship)
TRUCK CAPACITY - Every truck is at capacity
upon leaving terminal.

| | |
|---|---|
| RYDER | JB HUNT |
| KNIGHT TRANSPORTATION | YELLOW |
| CNF | US FREIGHTWAYS |

CARGO SHIP CAPACITY - Every ship is at capacity
upon leaving port.

| | |
|---|---|
| NIPPON CLASS NK | MAERSK SEALAND |
| HYUNDAI MERCHANT | EVERGREEN LINE |
| MARINE | |
| KAWASAKI KISEN KAISHA | TOTEM OCEAN TRAILER EXPRESS |

CARGO TRAIN CAPACITY - Every container on the
train is at capacity.

| | |
|---|---|
| CSX TRANSPORTATION | UNION PACIFIC (UP) |
| BURLINGTON NORTHERN | NORFOLK SOUTHERN |

CARGO PLANE CAPACITY- Every plane is at capacity
upon leaving terminal.

| | |
|---|---|
| FEDEX | UPS |
| DHL | EMERY |
| AIRBORNE | US MAIL |

The technology is designed to optimize travel profit by auctioning off available capacity. Vendors sign agreement with The auction company site to use the auction company site technology to sell off excess cargo capacity. Companies wishing to move cargo, sign-up and become a member by entering their billing and shipping information including name, mailing/billing address, credit card number or other payment information, phone number and email. Members will also be required to enter shipment preferences; Date, Time, Destination, Preferred method of shipment, Type of Cargo, Weight of Cargo, and Size of Cargo to streamline the auction process.

1) The vendor sets a predetermined time that the auction will start.

(X hours before the travel takes place)

2) One hour before the auction begins, the pricing software searches and identifies departures for a particular vendor with available cargo capacity. (ex. Empty Tractor trailer)

{The software runs this process every 10 minutes.}

3) Thirty-minutes before the auction begins, the pricing software makes one final search of departures for a particular vendor with available cargo capacity.

4) Thirty-minutes before the auction begins, the software sets a beginning auction, selling price based on:

a) Availability of cargo capacity

b) Time of day the travel will take place (am/pm)

c) Time of year the travel will take place (season)

d) Weather conditions in either the departure/arrival city

e) If a major event is taking place in either departure/arrival city (ex. Olympics in ATL)

f) Vendor daily profit goal or intended profit margin

g) Actual retail price of travel/event if purchased at that time

h) Average selling price of capacity (per sq foot) on the vessel (ex. Plane/Train/Ship)

5) Thirty-minutes before the auction begins, the software sends out email notifications to cargo broker agents and interested parties, letting them know that the auction will begin in thirty minutes.

6) Thirty-minutes before the auction begins, the software sends out customized banner and/or block advertisements for posting on cargo and/or event related websites informing site visitors of the auction.

7) At a predetermined time before the departure takes place, the auction starts. The pricing software posts the beginning bid price. Consumers will log into The auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the amount of cargo capacity auctioned plus any applicable taxes or surcharges.

b) A confirmation and receipt is emailed to the highest bidder.

10) After the auction ends and available capacity is sold, The auction company site charges predetermined processing fee(s), for example $1 dollar to the highest bidder and $1 dollar to the vendor selling the ticket.

11) After the auction ends and the available capacity is not sold, The auction company site will not charge either party any processing fees.

12) After the auction ends and an item is not sold, the cargo capacity that was held for the auction becomes available for sale by the shipping company or capacity broker/agents.

13) Cargo Capacity sold at The auction company site is:

a) Non-refundable.

b) Non-cancelable.

c) Non-exchangeable.

d) Not subject to rain-checks or rebates for non-travel.

14) The auction company site is linked to all participating vendors extranet and intranet for real-time pricing and product information and availability.

15) The vendor avoids agent fees for selling the excess cargo capacity on The auction company site or licensing The auction company site technology for use on their own website.

Preferred Embodiment—Time Dependent Sales (Houses/Cars/etc.)

HOME SALES—For the urgent sales (ex. Relocation) or banks who want to unload foreclosures or inventory.

VEHICLE SALES—For the urgent sales (ex. Relocation) or new/used car dealers who want to improve their month/year-end bottom line.

EMERGENCY SALE OF ANY ITEM—Item must be sold by a predetermined time.

The technology is designed to optimize per item sales (profit) by auctioning off those item(s). Vendors sign agreement with The auction company site to use the auction company site technology to sell those item(s) before a pre-determined time. (Relocation) Consumers wishing to purchase an item(s), sign-up and become a member by entering their billing and shipping information including name, mailing/billing address, credit card number or other payment information, phone number and email.

1) The vendor sets a predetermined time that the auction will start.

(X hours before the Item(s) needs to be sold)

2) One hour before the auction begins, the pricing software searches and identifies available item(s) for sale for a particular vendor. (ex. Living Room Set for a family that is moving)

{The software runs this process every 10 minutes.}

3) Thirty-minutes before the auction begins, the pricing software makes one final search of available item(s) for sale for a particular vendor.

4) Thirty-minutes before the auction begins, the software sets a beginning auction, selling price based on:

a) Availability of item(s)

b) Time of day the sale of item(s) will take place (am/pm)

c) Time of year the sale of item(s) will take place (season)

d) Weather conditions in city where the sale of item(s) will take place

e) If a major event is taking place in city where the item(s) for sale are located

f) Vendor daily profit goal or intended profit margin

g) Actual retail price of item(s) for sale if purchased at that time

h) Vendor's estimated value of item(s) for sale

5) Thirty-minutes before the auction begins, the software sends out email notifications to travel agents, auction sites, moving companies and other interested parties, letting them know that the auction will begin in thirty minutes.

6) Thirty-minutes before the auction begins, the software sends out customized banner and/or block advertisements for posting on auction, moving, or item related websites informing site visitors of the auction.

7) At a predetermined time before the vendor wants the item(s) sold, the auction starts. The pricing software posts the beginning bid price. Consumers will log into the auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder' credit card is billed for the amount the item(s) are sold for plus any applicable taxes or surcharges.

b) A confirmation and receipt is emailed to the highest bidder.

10) After the auction ends and the item(s) posted are sold, The auction company site charges predetermined processing fee(s), for example $1 dollar to the highest bidder and $1 dollar to the vendor selling the ticket.

11) After the auction ends and the item(s) posted are not sold, The auction company site will not charge either party any processing fees.

12) After the auction ends and the posted item(s) are not sold, the posted item(s) that was held for the auction becomes available for sale by the seller or otherwise owner of the item(s).

13) Item(s) sold at The auction company site are:

a) Non-refundable.

b) Non-cancelable.

c) Non-exchangeable.

d) Not subject to rain-checks or rebates.

14) The auction company site is linked to all participating vendors extranet and intranet for real-time pricing and product information and availability.

15) The vendor avoids agent fees for selling item(s) on The auction company site or licensing The auction company site technology for use on their own website.

Preferred Embodiment - Companies offering Services and Accomodations
SERVICE COMPANIES - Use the auction company site
technology to maximize each hour of business day.

| | | |
|---|---|---|
| BEAUTY SALONS | SPAS | SELF-TANNING BEDS |
| MASSAGE | BARBER SHOPS | CAR REPAIR SHOPS |
| PHOTOGRAPHERS | MOVING | PRINTERS (KINKOS) |
| | COMPANIES | |
| HOME REPAIR | MAID SERVICES | LAWN/POOL CARE |
| TRAINERS | TUTORS | |

LIMOUSINE RENTALS - Each day without a rental
amounts to $0.00 income.
GOLF COURSES - To maximize tee-times throughout the day.
BOATING TRIPS - Deep-sea fishing, day
sightseeing and parasailing trips.
HOTEL ROOM CAPACITY - To raise the booking rate at hotels.

| | |
|---|---|
| HILTON HOTEL | STARWOOD LODGING |
| HYATT | MARRIOTT |
| SIX CONTINENTS | HOLIDAY INN |

TIME SHARES Use the auction company site technology to
fill time-share or season rental property pre-season.

The technology is designed to optimize per day profit by auctioning off remaining operating time at service businesses. Vendors sign agreement with The auction company site to use the auction company site technology to sell off excess operating time. Consumers wishing to utilize these services, sign-up and become a member by entering their billing and shipping information including name, mailing/billing address, credit card number or other payment information, phone number and email. Members will also be required to preferred date service needed, type of service, number items or people that require service, and number of hours/days service is needed to streamline the auction process.

1) The vendor sets a predetermined time that the auction will start.

(X hours before the service day ends)

2) One hour before the auction begins, the pricing software searches and identifies excess operating time at participating vendors. (ex. Plumber with no more business at 11:00 am)

{The software runs this process every 10 minutes.}

3) Thirty-minutes before the auction begins, the pricing software makes one final search of excess operating time at participating vendors.

4) Thirty-minutes before the auction begins, the software sets a beginning auction, selling price based on:

a) Availability of service providers

b) Time of day the service will take place (am/pm)

c) Time of year the service will take place (season)

d) Weather conditions in city where service will be provided

e) If a major event is taking place in city where service is being provided (ex. Flood)

f) Vendor daily profit goal or intended profit margin

g) Actual retail price of service if purchased at that time

h) Average selling price of service (Weekly/Monthly/Annually)

5) Thirty-minutes before the auction begins, the software sends out email notifications to travel agents, service promoters, hotels, corporate planners and other interested parties, letting them know that the auction will begin in thirty minutes.

6) Thirty-minutes before the auction begins, the software sends out customized banner and/or block advertisements for posting on travel, event and/or service related websites informing site visitors of the auction.

7) At a predetermined time before the end of the business day, the auction starts. The pricing software posts the beginning bid price. Consumers will log into The auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the cost of the service that will be provided plus any applicable taxes or surcharges.

b) A confirmation and receipt is emailed to the highest bidder.

10) After the auction ends and the excess operating (service) time is sold, The auction company site charges predetermined processing fee(s), for example $1 dollar to the highest bidder and $1 dollar to the vendor selling the tickets.

11) After the auction ends and the excess operating (service) time is not sold, The auction company site will not charge either party any processing fees.

12) After the auction ends and the excess operating (service) time is not sold, the excess service time that was held for the auction becomes available for sale by the vendor.

13) Excess operating (service) time sold at The auction company site is:

a) Non-refundable.

b) Non-cancelable.

c) Non-exchangeable.

d) Not subject to rain-checks or rebates for non-attendance.

14) The auction company site is linked to all participating vendors extranet and intranet for real-time pricing and product information and availability.

15) The vendor avoids agent fees for selling the excess operating (service) time on The auction company site or licensing The auction company site technology for use on their own website.

Preferred Embodiment - Rental Companies (Daily/Weekly)
RENTAL CARS - To raise the booking rate of certain or all cars.

| | |
|---|---|
| HERTZ | AVIS |
| ENTERPRISE | ALAMO |
| DOLLAR | THRIFTY |

EQUIPMENT RENTALS - Each day without a rental amounts
to $0.00 income.
CONSTRUCTION EQUIPMENT PARTY EQUIPMENT
TOOLS

The technology is designed to optimize per item rental profit by auctioning off available use of item. Vendors sign agreement with The auction company site to use the auction company site technology to sell off excess rental use of item (Time). Companies wishing to rent an item, sign-up and become a member by entering their billing and shipping information including name, mailing/billing address, credit card number or other payment information, phone number and email. Members will also be required to enter rental preferences; Date, Time, Destination, Type of Equipment, Length of time required for rental, and where equipment will be used, to streamline the auction process.

1) The vendor sets a predetermined time that the auction will start.

(X hours before the rental takes place)

2) One hour before the auction begins, the pricing software searches and identifies available rental item (Time) for a particular vendor. (ex. Non-rented cars at Hertz)

{The software runs this process every 10 minutes.}

3) Thirty-minutes before the auction begins, the pricing software makes one final search of available rental item (Time) for a particular vendor.

4) Thirty-minutes before the auction begins, the software sets a beginning auction, selling price based on:

a) Availability of rental item (Time)

b) Time of day the rental will take place (am/pm)

c) Time of year the rental will take place (season)

d) Weather conditions in city where rental will take place

e) If a major event is taking place in city where rental will take place

f) Vendor daily profit goal or intended profit margin

g) Actual retail price of rental if purchased at that time

h) Average selling price of rental (daily)

5) Thirty-minutes before the auction begins, the software sends out email notifications to travel agents, party planners, contractors and other interested parties, letting them know that the auction will begin in thirty minutes.

6) Thirty-minutes before the auction begins, the software sends out customized banner and/or block advertisements for posting on travel and/or rental related websites informing site visitors of the auction.

7) At a predetermined time before the vendor wants the item rented, the auction starts. The pricing software posts the beginning bid price. Consumers will log into The auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the amount of the rental plus any applicable taxes or surcharges.

b) A confirmation and receipt is emailed to the highest bidder.

10) After the auction ends and available rental item (Time) is sold, The auction company site charges predetermined processing fee(s), for example $1 dollar to the highest bidder and $1 dollar to the vendor selling the ticket.

11) After the auction ends and the available rental item (Time) is not sold, The auction company site will not charge either party any processing fees.

12) After the auction ends and the rental item (Time) is not sold, the rental item that was held for the auction becomes available for sale by the rental company, rent broker or travel agent.

13) Any rental Item (Time) sold at The auction company site is:

a) Non-refundable.

b) Non-cancelable.

c) Non-exchangeable.

d) Not subject to rain-checks or rebates for non-rental.

14) The auction company site is linked to all participating vendors extranet and intranet for real-time pricing and product information and availability.

15) The vendor avoids agent fees for selling the rental item (Time) on The auction company site or licensing The auction company site technology for use on their own website.

Preferred Embodiment - Events (Sporting/Concert/Theater)
EVENT TICKETS To raise the percentage of tickets sold.

| | |
|---|---|
| CONCERTS | THEATER |
| SPORTING EVENTS | |

The technology is designed to optimize per event profit by auctioning off available tickets to that event. Vendors sign agreement with The auction company site to use the auction company site technology to sell off excess tickets. Consumers wishing to attend an item, sign-up and become a member by entering their billing and shipping information including name, mailing/billing address, credit card number or other payment information, phone number and email. Members will also have the option of entering event preferences; Preferred Seating Location and Number of Seats Needed, to streamline the auction process.

1) The vendor sets a predetermined time that the auction will start.

(X hours before the event takes place)

2) One hour before the auction begins, the pricing software searches and identifies available event item for a particular vendor. (ex. Unsold tickets at Eagles concert)

{The software runs this process every 10 minutes.}

3) Thirty-minutes before the auction begins, the pricing software makes one final search of available event tickets for a particular vendor.

4) Thirty-minutes before the auction begins, the software sets a beginning auction, selling price based on:

a) Availability of event tickets

b) Time of day the event will take place (am/pm)

c) Time of year the event will take place (season)

d) Weather conditions in city where event will take place

e) If another major event is taking place in city where event will take place

f) Vendor daily profit goal or intended profit margin

g) Actual retail price of event tickets if purchased at that time

h) Average selling price of event ticket

5) Thirty-minutes before the auction begins, the software sends out email notifications to travel agents, concert promoters and other interested parties, letting them know that the auction will begin in thirty minutes.

6) Thirty-minutes before the auction begins, the software sends out customized banner and/or block advertisements for posting on travel, concert and/or event related websites informing site visitors of the auction.

7) At a predetermined time before the event takes place, the auction starts. The pricing software posts the beginning bid price. Consumers will log into The auction company site and bid up the price. If Vendor wants The auction company site technology to run in the background (private-label) of their own website, consumers would log into that website.

8) Thirty-minutes after the auction has begun, email notices and/or customized advertisements are again sent out to inform users that the auction will be ending in thirty minutes.

9) One hour after the auction began, it ends. The highest bidder is the winner. Also at that time:

a) Highest bidder's credit card is billed for the amount of the event plus any applicable taxes or surcharges.

b) An e-ticket is sent to the highest bidder via email.

c) A confirmation and receipt is emailed to the highest bidder.

10) After the auction ends and available event tickets are sold, The auction company site charges predetermined processing fee(s), for example $1 dollar to the highest bidder and $1 dollar to the vendor selling the tickets.

11) After the auction ends and the available event tickets are not sold, The auction company site will not charge either party any processing fees.

12) After the auction ends and the event tickets are not sold, the event tickets that were held for the auction becomes available for sale by the event company, rent broker or travel agent.

13) Event Tickets sold at The auction company site are:

a) Non-refundable.

b) Non-cancelable.

c) Non-exchangeable.

d) Not subject to rain-checks or rebates for non-attendance.

14) The auction company site is linked to all participating vendors extranet and intranet for real-time pricing and product information and availability.

15) The vendor avoids agent fees for selling the event tickets on The auction company site or licensing The auction company site technology for use on their own website.

### DESCRIPTION OF THE DRAWINGS

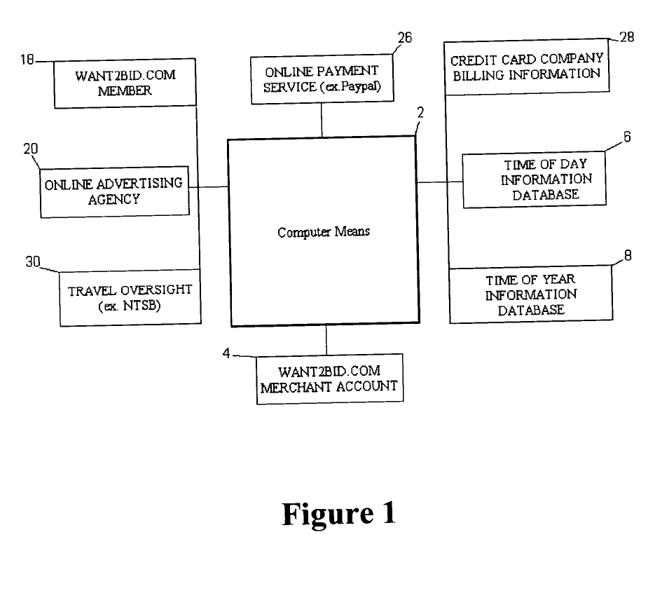

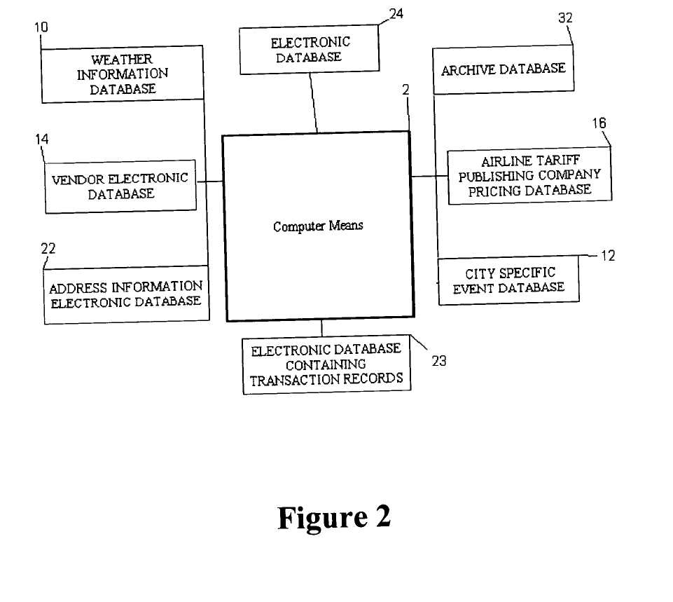

FIGS. 1 and 2 illustrate certain aspects of a system for carrying out the invention. The system illustrated and its constituent elements provides means for carrying out the various method steps described above. The auction site computer means 2 transmits information, instructions and queries to and receives needed and/or responsive information from the illustrated peripheral computers and databases, which can be internal or external to the auction site. These peripheral elements of the system in turn receive information, instructions and queries from and transmit responsive information to the computer means 2. Information pertaining to tickets being placed up for bid is received from merchant account 4. Information to be factored into auction reserve or beginning prices is retrieved from databases 6, 8, 10, 12, 14 and 16. Notices of auction are sent to site members 18 and 20, and bids may be received from these entities and associated with address information from database 22. Electronic database 22 keeps track of the progress of the auction and electronic database 24 maintains records of auction results. Billing and payment transactions are carried out with databases and systems 26 and 28. Government oversight is provided via communications with item 30. Archive database 32 provides storage of all dated transaction records.

While certain preferred embodiments of the invention have been described herein, the invention is not to be construed as being so limited, except to the extent that such limitations are found in the claims.

1. A method comprising
identifying an item which needs to be sold by a specified time,
offering the identified item for sale at an auction which takes place at a predetermined time prior to the specified time,
receiving bids for said item from at least one bidder, and
selling said item to a highest bidder.

2. A method as in claim 1 wherein the item to be sold comprises a vendor's time-dependent commitment to provide a service.

3. A method as in claim 2 wherein the service comprises a freight service selected from the group consisting of scheduled trucking services, shipping services, air freight services, and rail freight services having excess capacity.

4. A method as in claim 2 wherein the service comprises a personal service selected from the group consisting of an opening at a specific time for a limousine rental, a boat charter or tour, a moving company slot of availability, a photographer appointment, a beauty salon appointment, a tanning shop appointment, a tutor appointment.

5. A method as in claim 2 wherein the service comprises rental for a specific time period of personal property selected from the group consisting of equipment and automobiles.

6. A method as in claim 1 wherein the item to be sold comprises a vendor's time-dependent commitment to provide an accommodation.

7. A method as in claim 6 wherein the accommodation comprises a stay for a specific time period at a facility selected from the group consisting of a hotel or motel room, a bed and breakfast, a beach or ski condominium or weekly rental unit, a resort time share unit, and a meeting or banquet facility.

8. A method as in claim 6 wherein the accommodation comprises accommodation at a ticketed scheduled event selected from the group consisting of an airline flight, a bus departure, a train departure, a cruise, a sporting event, a concert, a play, and a movie.

9. A method as in claim 6 accommodation comprises a specific time for an admission to an amusement park or a tee time for a round of golf.

10. A method as in claim 1 wherein the item comprises a vendor's real or personal property.

11. A method as in claim 1 wherein
the offering of the item is made by an owner of the right to sell the item.

12. A method as in claim 11, the offering of the item is made by an internet auction site as an agent of an owner of the right to sell the item.

13. A method as in claim 12 wherein the offering is made on an internet auction site.

14. A method as in claim 1 wherein the item is identified by searching an electronic database belonging to an owner of the right to sell the item, and determining whether the owner has a capacity to sell the item.

15. A method as in claim 14 wherein the searching is conducted by the owner of the database.

16. A method as in claim 14 wherein the searching is conducted by an internet auction site.

17. A method as in claim 14 wherein the searching is conducted about one hour prior to a predetermined auction beginning time.

18. A method as in claim 10 further comprising
sending notices of the auction to predetermined recipients at a predetermined time prior to the predetermined auction beginning time.

19. A method as in claim 18 wherein the notices are transmitted over the internet.

20. A method as in claim 19 wherein the notices are transmitted to at least one recipient selected from the group consisting of auction site members, auction site users, travel agents, ticket agents, web home pages, and internet service provider home pages.

21. A method as in claim 20 wherein the notices are in the form of a communication selected from the group consisting of an Email, a pop-up ad, a banner and a block advertisement.

22. A method as in claim 21 wherein the notice lists item information, minimum bid information, auction beginning time and an auction closing time.

23. A method as in claim 20 wherein the notice displays a hot button to electronically link with an address selected from the group consisting of the auction site home page and the auction site for the item.

24. A method as in claim 23 wherein the notices are transmitted about 30 minutes prior to the auction beginning time.

25. A method as in claim 1 further comprising
setting a reserve price on the item.

27. A method as in claim 13 wherein the auction site is a page at an internet auction site.

28. A method as in claim 27 wherein the page displays item identification information, current bid price, and time remaining until end of auction.

29. A method as in claim 28 wherein the page displays hot buttons for making a bid and for accessing additional information.

30. A method as in claim 29 further comprising transmitting a bid amount on the item from a bidder to the auction site, transmitting bidder identity and contact information to the auction site, and transmitting payment information to the auction site.

31. A method as in claim 30 wherein the payment information is selected from the group consisting of credit card information, debit card information, and other.

32. A method as in claim 31 further comprising
determining the winning bidder at the auction end time.

33. A method as in claim 32 further comprising transmitting, after the auction end time, a successful bid notification to a winning bidder and a statement of charges.

34. A method as in claim 33 wherein the statement of charges includes a fee charged by the auction site.

35. A method as in claim 8 wherein
the ticketed event is selected from the group consisting of
an airline flight, a cruise, a sporting event, a concert, and a play.

36. A method as in claim 35 further comprising
beginning the auction at a predetermined auction beginning time prior to the ticketed event.

37. A method as in claim 36 further comprising
sending notices of the auction to predetermined recipients at a predetermined time prior to the predetermined auction beginning time.

38. A method as in claim 37 wherein the event is an airline flight, and the notices list identification of departure city and time of departure, and identification of destination city.

39. A method as in claim 38 wherein the notices further list carrier identification, class of seat information, and an arrival time in the destination city.

40. A method as in claim 38 wherein the notice lists a reserve price which is set based a predetermined relationship with at least one factor selected from the group consisting of:
a) Availability of seats
b) Location of seat or space
c) Time of day the travel/event takes place
d) Time of year the travel/event takes place
e) Weather conditions in either the departure/arrival city
f) If a major event is taking place in either departure/arrival city (e.g. Olympics)
g) Vendor daily profit goal or intended profit margin
h) Actual retail price of travel/event if purchased at that time
i) Average selling price of tickets on the flight or at the event
j) pricing information obtained from the Airline Tariff Publishing Company, and
k) Cost per seat mile multiplied by the number of miles on flight.

41. A method comprising
identifying surplus capacity, according to predetermined criteria, for providing accommodation or services at a specific future time or time period,
offering a contract to provide all or a portion of such surplus capacity at an auction,
receiving bids for said contract from at least one bidder, and
selling said contract to a highest bidder, thereby reducing the surplus capacity.

42-48. Cancelled

49. A method comprising
identifying surplus capacity, according to predetermined criteria, for a future event for which tickets are sold, said future event being capacity limited,
offering at least one surplus ticket representative of a contract to provide personal accommodation at the future event from said surplus capacity at an auction,
receiving bids for said at least one surplus ticket from at least one bidder, and
selling said surplus ticket to a highest bidder, thereby reducing the surplus capacity.

50-79. Cancelled
